(19) United States
(12) Patent Application Publication
(10) Pub. No.: US 2012/0055122 A1
(43) Pub. Date: Mar. 8, 2012

(54) APPARATUS AND METHOD FOR DISTRIBUTION OF PACKAGED ITEMS

(76) Inventor: Serge Andre BEAUCHAMP, Ottawa (CA)

(21) Appl. No.: 13/224,602

(22) Filed: Sep. 2, 2011

Related U.S. Application Data
(60) Provisional application No. 61/379,884, filed on Sep. 3, 2010.

(51) Int. Cl. B60R 11/00; B67B 7/00

(52) U.S. Cl. 53/492; 108/44

(57) ABSTRACT

Disclosed herein is a platform for the transfer of a plurality of items from a base level on a transportation device, to a second location, the platform comprising: (a) a frame; (b) a base for supporting the plurality of items, the base attached to the frame; and (c) one or more members for engagement of the platform in both a deployed position and a stored position with the transportation device; wherein the deployed position is at a higher level on the transportation device than the base level of the transportation device. The platform may be removably or fixedly attached to the transportation device. In addition, there is disclosed a method for the transfer and placement of a plurality of items from a lower level of a transportation device, to a second location.

### TECHNICAL FIELD

The present disclosure relates to use of an apparatus and method to facilitate distribution of items, such as, but not limited to, beverages. More particularly, the present invention relates to a platform for use with a handcart used for the transport and placement of a plurality of items.

### BACKGROUND

A handcart is often used for the transport of a plurality of items that will be subsequently restocked elsewhere. The items are often assembled in packages for transportation to a certain destination. Once at that destination, the packages are further transported (via handcart or similar device) to a location where the items are removed from their packaging and stocked individually.

Prior to stocking, the packages are stacked onto the bottom-loading panel of a handcart (or similar device). The worker then transports the packages to the stocking location, where the items in the top-most packaging are unloaded, and the items are placed or stacked at a second appropriate location (e.g. shelves, vending machines, coolers etc). The worker then proceeds to the next package of items, and so on, until the bottom-most package is reached. At this point, the worker reaches nearly to the ground to obtain the items from the last package, and must then lift the remaining items to their stocking location.

The repetitive motion of bending and lifting often leads to back strains, especially as the user bends down to the lower stacks, and then subsequently lifts the items to a higher level. Furthermore, the manual transportation of articles from a lower level to a higher level, takes time.

U.S. Pat. No. 7,873,542 discloses a method of distributing product utilizing preloaded mini-pallets in which orders are preloaded on mini-pallets, placed in a trailer and then offloaded by account location with a hand truck.

U.S. Pat. No. 7,856,932 discloses a stackable packaged goods pallet for shipping and displaying of packaged goods. The pallet comprises a plurality of stacking feet joined together by angled ribs; a plurality of handles; and an angled surface on the bottom of the stacking feet to facilitate transporting of the loaded pallet from a distribution vehicle to a retail location over certain obstacles. The packaged goods can comprise beverage trays filled or partially filled with beverage bottles, or any good and/or raw material for sale and/or use in manufacturing.

U.S. Pat. No. 6,626,634 discloses a method of distributing beverages with improved shipping tray, in which a mini-pallet is used to create, organize, and move product stacks. When not loaded, the mini-pallet is capable of “nesting” within another mini-pallet for convenient storage.

U.S. Pat. No. 6,880,851 discloses a hand cart for facilitating moving of groceries to a desired location. The hand cart includes a frame assembly comprising a pair of side members and a handle member. A lower shelf assembly is hingeably coupled to the frame assembly opposite the handle member of the frame assembly. The lower shelf assembly is pivotal between a deployed position and a stored position. The lower shelf assembly is designed for receiving groceries for facilitating transportation of the groceries across the surface by the user when the lower shelf assembly is in the deployed position.

U.S. Pat. No. 6,932,363 discloses a collapsible and portable cart for transporting different items, while shopping, gardening, laundry, transporting boxes or luggage, etc. The cart has base portion with wheels, and a first foldable basket for heavy loads; and the rapper portion, that has a second foldable basket. Both baskets have locking mechanism to keep the foldable screens in an upright position.

U.S. Pat. No. 7,168,715 discloses a collapsible cart for transporting multiple items having a horizontal platform with wheels for manoeuvring, and a plurality of detachable baskets mounted on basket supporting assemblies. The basket supporting assemblies are pivotally mounted so as to be capable of independent deployment and stowing to facilitate loading and unloading in turn.

U.S. Pat. No. 7,823,893 discloses a hand truck that includes a shelf position changer configured to provide means for changing the position of a movable shelf on the base so as to vary the height of the movable shelf.

U.S. Patent Publication No. 20090309323 discloses an equipment carrier for transporting one or more work items that includes a vertical frame attached to a base frame. In one embodiment, work piece arms for supporting work items are pivotally connected to the front of the vertical frame allowing them to swing into horizontal position and then fold down into a vertical position.

U.S. Design Pat. No. D577,172 discloses a cart with upper trays fixed to a base, that can be folded vertically, while U.S. Design Pat. No. D548,421 discloses a shopping cart with an upper tray fixed to a base, that can be folded vertically.

It would therefore be desirable to have a device that reduces physical strain, while allowing the user to deliver the items in a more efficient manner.

### SUMMARY

In one aspect of the present disclosure, there is provided a platform for the transfer of a plurality of items from a base level on a transportation device, to a second location, the platform comprising: (a) a frame; (b) a base for supporting the plurality of items, the base attached to the frame; and (c) one or more members for engagement of the platform in both a deployed position and a stored position with the transportation device; wherein the deployed position is at a higher level on the transportation device than the base level of the transportation device.

The platform may further comprise a peripheral lip which may extend around all of the frame, or a portion thereof. The peripheral lip may serve to restrain the plurality of items. In addition, the lip may be integral with the frame.

The platform may be removably attached to the transportation device, in which case one or more deployment attachment members are used to engage the platform in the deployed position, and one or more storage attachment members are used to engage the platform in the stored position. Alternatively, the platform may be fixedly attached to the transportation device. The frame may be made of lightweight material or steel, and the base may be made of lightweight material. The base may be solid or may have one or more perforations. When perforated, the perforations may be random, or may be patterned. The plurality of items may be packaged merchandise, which may comprise beverage bottles, or any good and/or raw material for sale and/or use in manufacturing. In addition, the packaged merchandise may comprise a tray within the packaging, or may be trayless.

In another aspect of the present disclosure, there is provided a platform for the transfer of a packaged items stored at a base level on a transportation device, to a second location, the platform removably attached to the transportation device, the platform comprising: (a) a frame; (b) a base for supporting the packaged items, the base attached to the frame; (c) one or more deployment attachment members for engaging the platform with the transportation device in a deployed position, and (d) one or more storage attachment members for engaging the platform in a stored position, wherein the deployed position is at a level higher on the transportation device than the base level of the transportation device.

The base of the platform may be solid or may have one or more perforations. When perforated, the perforations may be random or patterned. Furthermore, the platform may comprise a peripheral lip that may, or may not, extend completely around the periphery of the platform. The frame may be made of the lightweight material or steel and the base may be made of a lightweight material. In addition, the packaged items may may comprise beverage bottles, or any good and/or raw material for sale and/or use in manufacturing. In addition, the packaged merchandise may comprise a tray within the packaging, or may be trayless.

In a further aspect of the present disclosure, there is provided a method of transferring and placing packaged items, comprising the steps of: (a) loading one or more units of the packaged items onto a base level of a transportation device, the transportation device having a platform in a stored position removably attached thereto; (b) transporting the transportation device to a location where the packaged items are to be unloaded and placed; (c) removing the platform from the stored position; (d) attaching the platform in a deployed position onto the transportation device, the deployed position being at a level higher than the base level; (e) transferring one or more units of the packaged items from the base level onto the platform; (f) removing packaging from the packaged items; (g) placing the items removed from the packaging in step (f), onto a second location; and (h) repeating steps (e), (f) and (g) until most, or all, of the packaged items have been placed onto the second location; wherein the platform comprises: a frame; a base for supporting the packaged items, the base attached to the frame; one or more deployment attachment members for engaging the platform with the transportation device in the deployed position, and one or more storage attachment members for engaging the platform in the stored position.

The platform may further comprise a peripheral lip for restraining the packaged items; the lip may extend around the entire periphery of the platform, or a portion thereof. The packaged items may be packaged merchandise, which may comprise beverage bottles, or any good and/or raw material for sale and/or use in manufacturing. In addition, the packaged merchandise may comprise a tray within the packaging, or may be trayless.

In yet a further aspect of the present disclosure, there is provided a method of transferring and placing packaged items, comprising the steps of: (a) loading one or more units of the packaged items onto a base level of a transportation device, the transportation device having a platform in a stored position attached thereto; (b) transporting the transportation device to a location where the packaged items are to be unloaded and placed; (c) moving the platform from the stored position to a deployed position, the deployed position being at a level higher than the base level; (d) transferring one or more units of the packaged items from the base level onto the platform; (e) removing packaging from the packaged items; (f) placing the items removed from the packaging in step (e), onto a second location; and (g) repeating steps (d), (e) and (f) until most, or all, of the packaged items have been placed onto the second location; wherein the platform comprises: a frame; a base for supporting the packaged items, the base attached to the frame; and one or more attachment members for engagement of the platform in both the deployed position and the stored position with the transportation device.

The platform, may be fixedly attached to the transportation device. Alternatively, the platform may be removably attached to the transportation device, in which case one or more deployment attachment members are used to engage the platform in the deployed position, and one or more storage attachment members are used to engage the platform in the stored position. The base of the platform may be solid or may have one or more perforations. When perforated, the perforations may be random or patterned. Furthermore, the platform may comprise a peripheral lip that may, or may not, extend completely around the periphery of the platform. The frame may be made of the lightweight material or steel and the base may be made of a lightweight material. In addition, the packaged items may comprise beverage bottles, or any good and/or raw material for sale and/or use in manufacturing. In addition, the packaged merchandise may comprise a tray within the packaging, or may be trayless.

In yet another aspect of the disclosure there is provided a platform for use with a handcart; where the platform is deployed at an upper level of the handcart, thereby providing a raised platform to temporarily hold packaged items. The worker can then remove and stock items from the packaging, at a physical level that reduces strain, and reduces the time required to shelve the items.

The platform is in a stored position when the user first transports a plurality of packages of items. In the stored position, the platform does not interfere with the stacking of the packages onto the bottom-loading platform of the handcart.

Once the worker arrives at the prerequisite destination to unload the items, s/he can unload the first few stacks. However, instead of bending down to unload the remaining items, s/he can place the platform in a deployed position, thereby providing a higher level upon which to place the remaining packages of items. The user then removes the remaining items from the packaging, and places them onto the desired location, without having to bend down to a lower level.

Alternatively, the worker can place the package of items directly onto the platform in its deployed position, rather than on the bottom-loading platform of the handcart. This is a preferred option when the packaged merchandise is packaged without a tray. Or, the worker can use a combination of the bottom-loading platform and the appended platform for transport and unloading of the packaged items.

The platform may be used for the transport and stocking of items that require shelving, placement into vending machines, placement into coolers, etc. The items may be in the form of packaged merchandise, which can comprise beverage bottles, or any good and/or raw material for sale and/or use in manufacturing. In addition, the packaged merchandise may, or may not, comprises a tray within the packaging. The platform may also be used to hold/collect money retrieved from vending machines, after the packaged items have been placed therein.

The platform may be detached manually from the handcart, and stored adjacent to the cart. Alternatively, the platform may be moved between the deployed and stored positions without detachment from the handcart. Where the platform is not detached as it moves between deployment/storage, the platform may be attached directly to the handcart, or via an intermediary means, to the hand cart.

In the aforementioned summary, the transportation device may be a hand cart, or dolly, that is often used for the transport of packaged items to a second location. The second location may be a vending machine, store shelves, a display counter, or the like.

The foregoing summarizes the principal features of the method and apparatus for distribution of a plurality of items, and some of its optional aspects. The method and apparatus may be further understood by the description which follows.

Wherever ranges of values are referenced within, this specification, sub-ranges therein are intended to be included within the scope of the invention unless otherwise indicated. Where characteristics are attributed to one or another variant, unless otherwise indicated, such characteristics are intended to apply to all other variants where such characteristics are appropriate or compatible with such other variants.

### BRIEF DESCRIPTION OF DRAWINGS

FIGS. 1 and 1A illustrate a perspective view of a first and second embodiment, respectively of a platform.

FIG. 2 illustrates a rear perspective view of a second embodiment of a platform.

FIG. 3 illustrates a front plan view of the platform illustrated in FIG. 2.

FIG. 4 illustrates a front plan view of a third embodiment of a platform.

FIGS. 5A and 5B illustrate a perspective view and side planar view, respectively, of a fourth embodiment of a platform.

FIGS. 6A and 6B illustrate a rear and side planar view, respectively, of a platform attached in a deployed position, to a hand cart.

FIGS. 7A and 7B illustrate a rear and side planar view, respectively, of a platform attached in a stored position, to a hand cart.

FIGS. 8A, 8B and 8C illustrate a side, front and rear planar view, respectively, of a platform attached by a bracket in a deployed position, to a hand cart.

FIG. 9 illustrates a front view of the platform shown in FIGS. 8A-8C, in an stored position.

### DETAILED DESCRIPTION OF PREFERRED EMBODIMENTS

The following is given by way of illustration only and is not to be considered limitative of the platform and method for distribution of a plurality of items. Many apparent variations are possible without departing from the scope thereof.

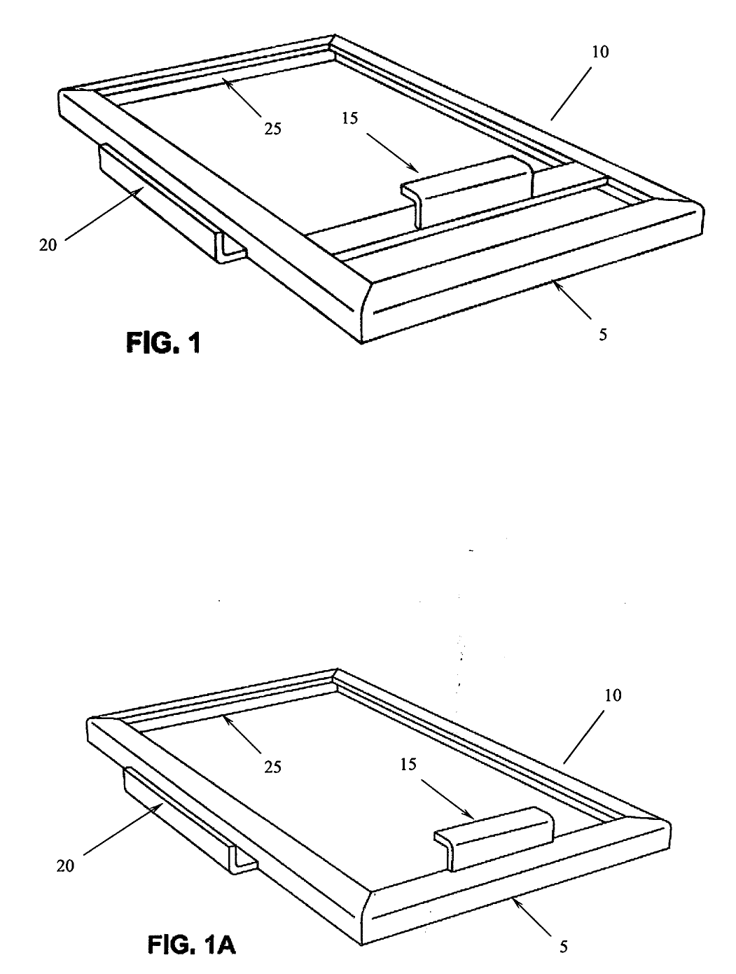

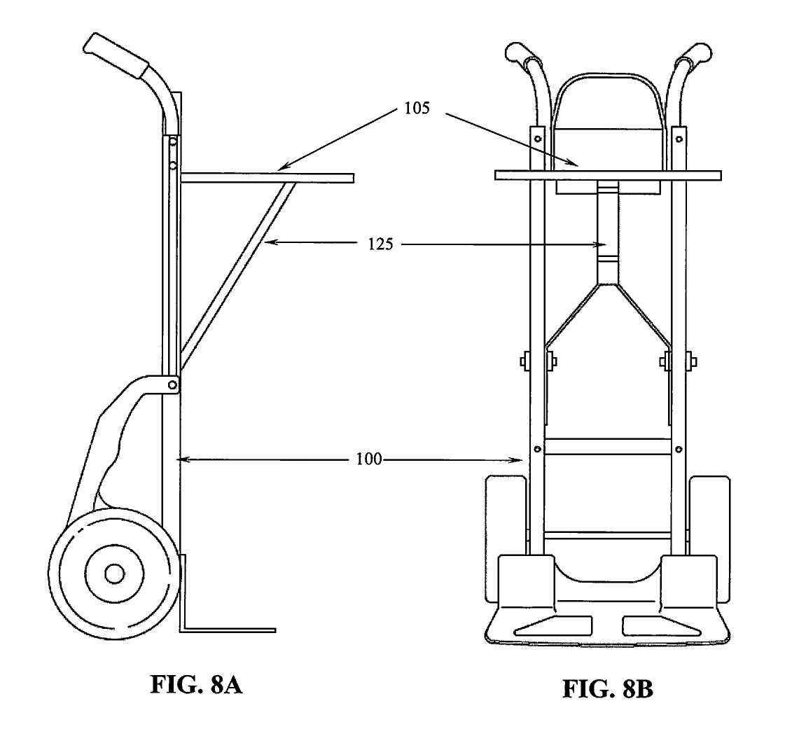

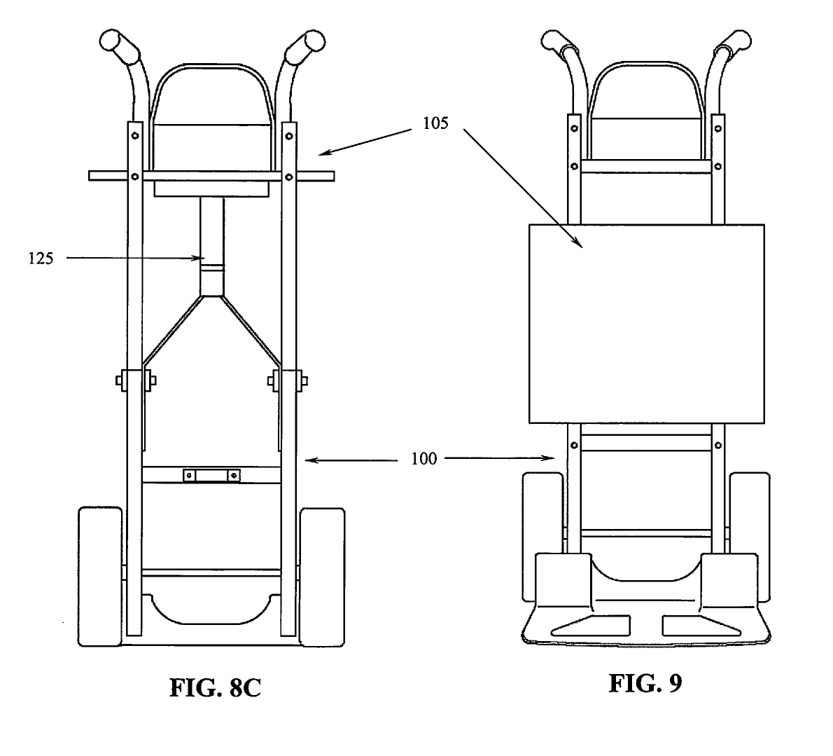

FIGS. 1-7 illustrate embodiments in which a platform is removably attached to a transportation device, while FIGS. 8-9 illustrate embodiments in which a platform is fixedly attached to a transportation device.

FIGS. 1 and 1A illustrate an underside perspective view of preferred embodiments of a frame (5) of a platform (10) which is detachable from a transportation device, in which the base has been removed for the purpose of illustration only.

The frame can be sized according to the requirements of the user—namely, the size of the packaging that will be stacked. While the frame (5) is illustrated with a rectangular shape, it is not limited thereto, and can have any shape.

In the embodiments shown in FIGS. 1 and 1A, the frame (5) is detachable from a transportation device (not shown). The frame (5) is attached to the transportation device (for example, but not limited to, a handcart) in a deployed position via a deployment attachment member (20). The deployed position refers to a position of the platform wherein packaged items can be stored/stacked on the platform.

A storage attachment member (15) serves to attach the frame (5) when the platform (10) is in a stored position; i.e. when packaged items are note stored/stacked on the platform (10). As shown in FIG. 1, the storage attachment member (15) can be integral with an edge of the frame (5), or, as shown in FIG. 1A, the storage attachment member (15) can be displaced from an edge of the frame (5).

The exact shape of the deployment and storage attachment members (15, 20) is not limited to that shown in FIGS. 1 and 1A; any shape and/or form applies so long as the frame (5) attaches to the specifications of the transportation device. Similarly, the point of location of the deployment and storage attachment members (15, 20) on the frame (5) is not limited to those shown in FIGS. 1 and 1A; any location of each of these attachment members (15, 20) applies so long as the platform (10) attaches to the transportation device in a deployed and stored position.

The frame may be constructed of any lightweight material or steel. The lightweight material includes, but is not limited to, extruded aluminum or plastic.

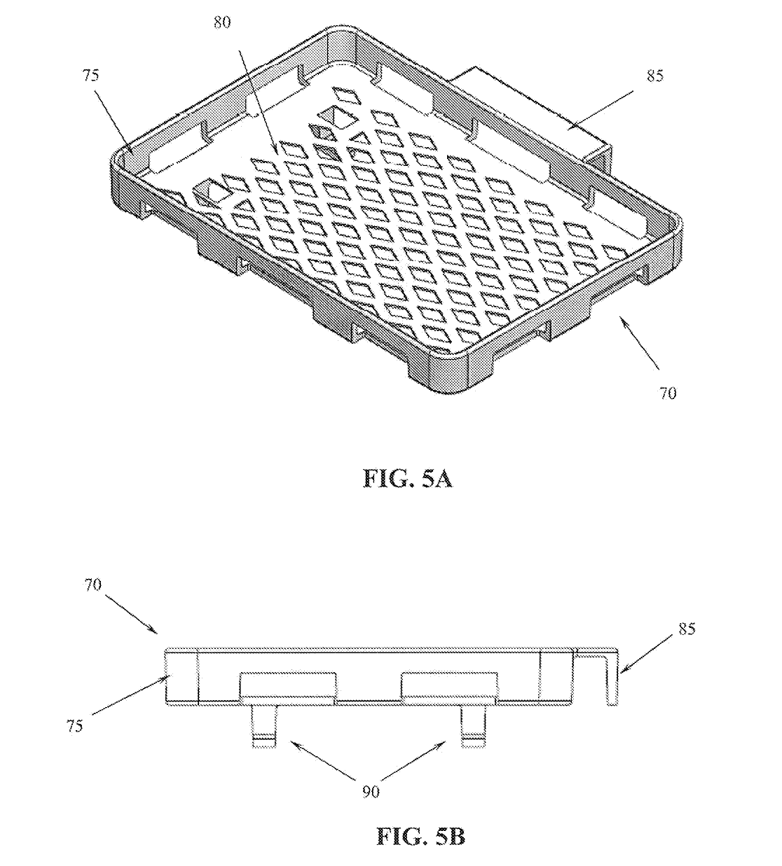

An optional feature of the frame includes a peripheral lip or raised edge (25) that may extend around the entire perimeter of the frame (5), or a portion thereof. This optional lip (25) may be used for packaged items that require external reinforcement so as not to spill or slip off the platform. This includes, by way of example, “trayless” beverage packages. Once the packaging is opened for stocking, the beverages may spill or slip off the platform if there is no external reinforcement. The optional lip (25) may be integral with the frame (5), as shown in FIG. 5. Or, it may alter between an engaged and disengaged position with the frame (5).

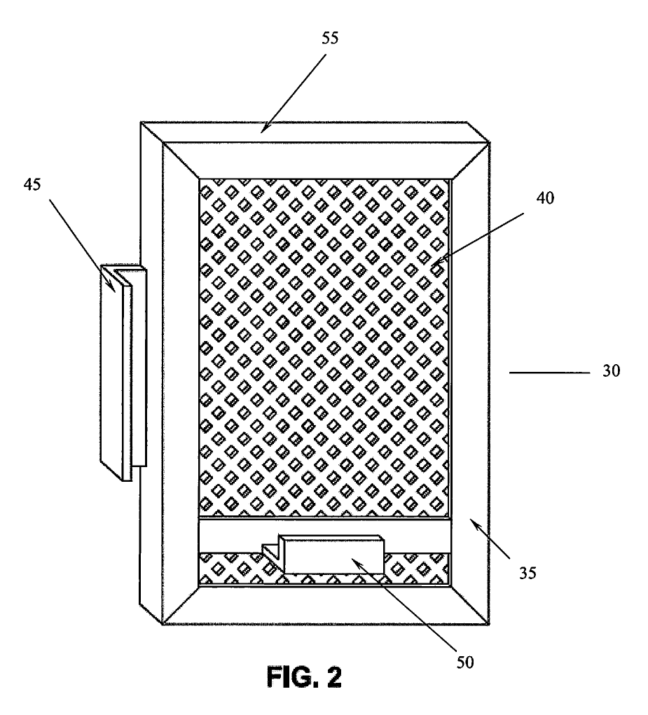

FIG. 2 illustrates an underside front perspective view of another embodiment of a platform (30). The platform (30) consists of a frame (35), a base (40), a deployment attachment member (45) and a storage attachment member (45). The base (40) may be solid, or perforated, as shown in FIG. 2. The perforations may be random or patterned in any manner, so long as the base (40) provides a stable platform upon which to place a plurality of packaged items.

The base (40) may be constructed of any material that meets the strength requirement to carry a plurality of packaged items. This includes, but is not limited to, expanded steel, or lightweight material. The lightweight material includes, but is not limited to, aluminum or plastic. As an example, as shown in FIG. 2, the base (40) is made of expanded steel mesh. In the embodiment of FIG. 2, a peripheral lip (55) extends around a perimeter of the frame (35). However, it is understood that the peripheral lip (55) is an optional feature of the platform (30).

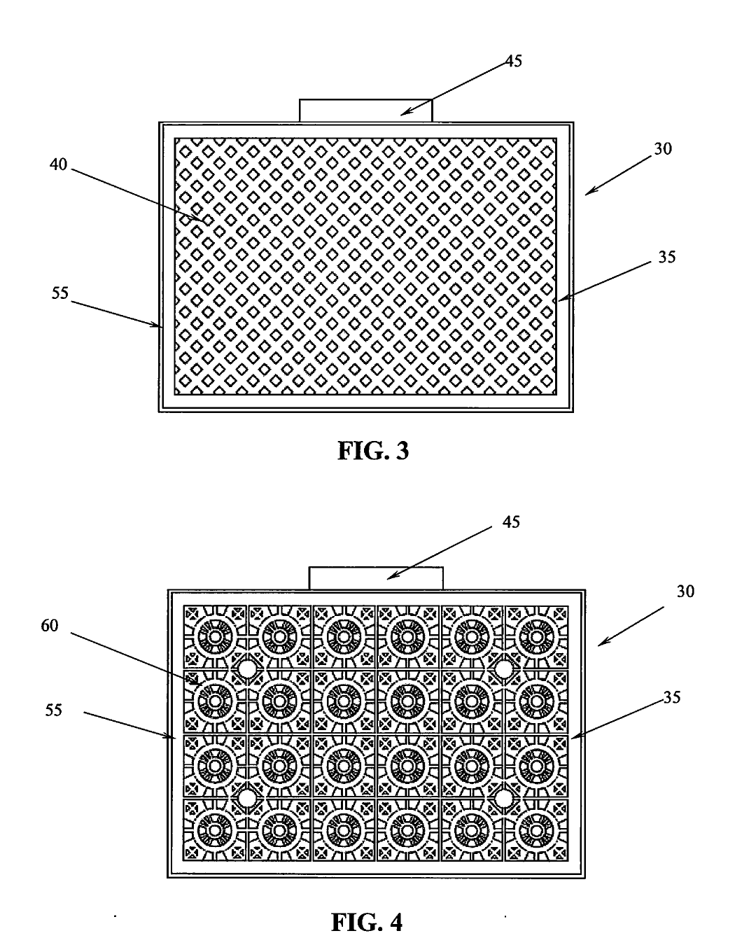

FIG. 3 illustrates a front planar view of the platform (30) shown in FIG. 2, in which the frame (35), deployment attachment member (40), and peripheral lip (55) are shown.

FIG. 4 illustrates a platform similar to that of FIG. 3, except for the pattern of the base (60), which may be used for the transport and placement with a circular base, such as, but not limited to, a tray of beverage bottles (not shown).

FIGS. 5A and 5B illustrate yet another embodiment of a platform. In the perspective view of FIG. 5A, a platform (70) comprises a frame with an integral peripheral lip (75), a base (80) with a perforated pattern, and a deployment attachment member (85). In this embodiment, the frame and peripheral lip form an integral unit.

A side planar view of the platform (70), shown in FIG. 5B, illustrates the presence of two storage attachment members (90). While two storage attachment members are shown, it is understood that, in general, one or more storage members may form part of the platform. Similarly, while one deployment attachment member is shown, it is understood that one or more deployment attachment members may be used.

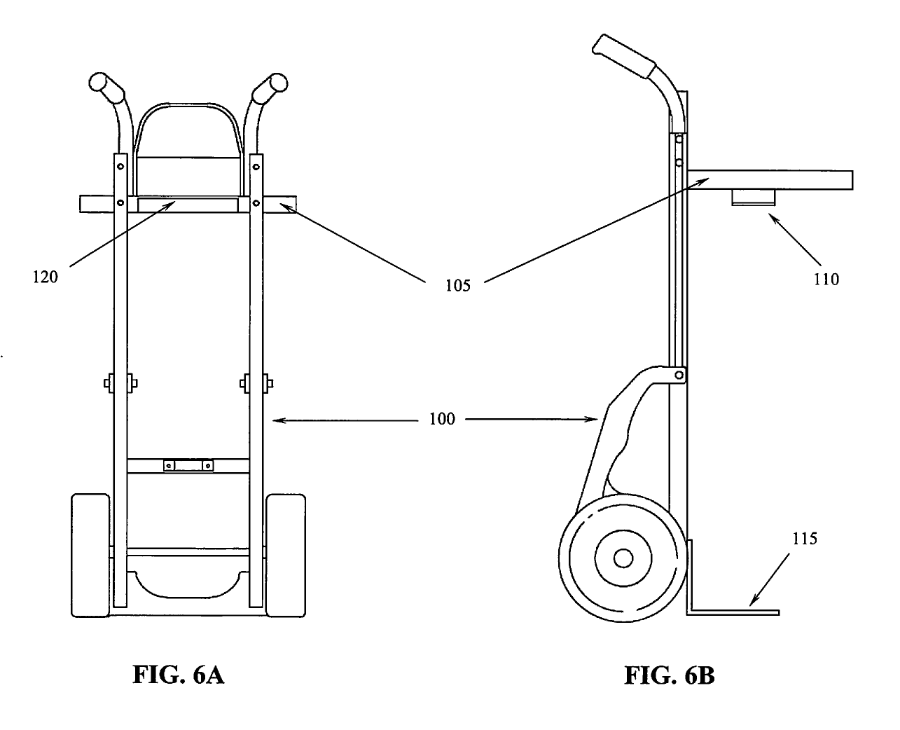

FIG. 6A illustrates a rear view of a platform of (105) as it engages a handcart (100) in a deployed position via a deployment attachment member (120). The deployment attachment member (120) snaps onto a handcart rail, thereby maintaining the platform (105) in a deployed position. The platform (105) can engage the handcart (100) at any location on the handcart, although the uppermost handcart rail is a preferred location of engagement. A plurality of packaged items are placed on the lower platform (115) of the handcart (100), and then transferred, preferably one by one, to the platform (105), and shelved therefrom, without the user having to bend down repeatedly to the lower platform (115) in order to transport and place merchandise to another location.

FIG. 6B illustrates a side planar view of the embodiment shown in FIG. 6A, in which a storage attachment member (110) of the platform (105) is shown.

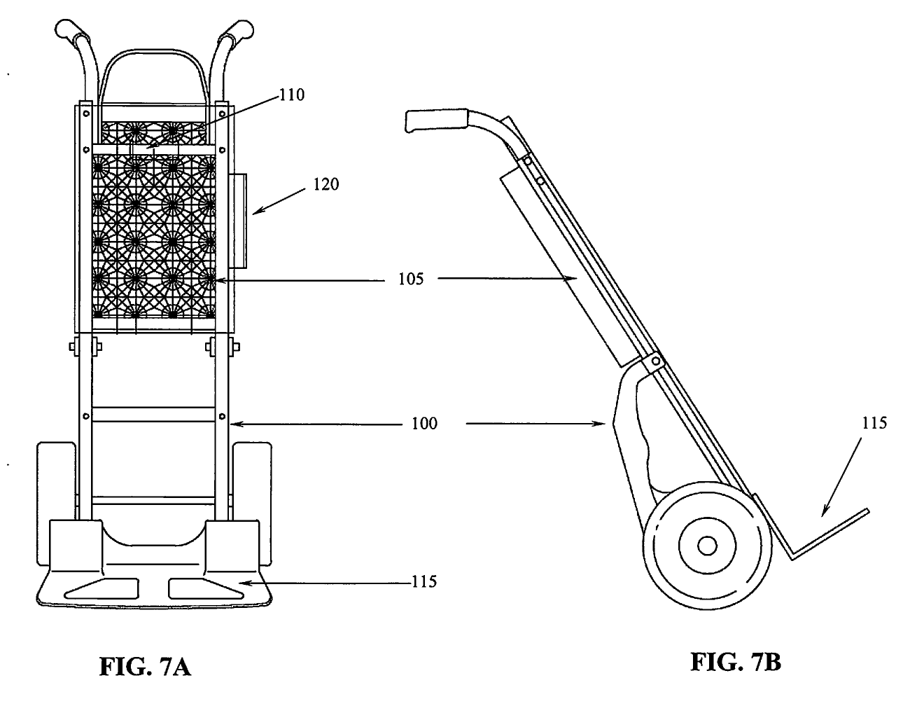

FIG. 7A illustrates a platform (105) in a stored position at the rear of the handcart (100) via a storage attachment member (110). The platform (105) is maintained in this position when not in use—for example, when transporting a plurality of items which are stacked on the lowest platform (115) of the handcart (100). The storage of the platform (105) is also shown in FIG. 7B. While FIGS. 7A and 7B illustrate a platform (105) stored on the rear of the handcart (100), the platform (105) is not restricted for storage at such location; the platform (105) may be stored anywhere on the handcart.

The platform (105) is moved from the deployed position to the stored position by detaching the deployment attachment member (120) from the handcart (100) rail, moving the platform (105) into a vertical position, and attaching the platform (105) to the hand cart (100) rail by the storage attachment member (110). The platform (105) can be stored either at the front or the rear of the handcart (100), on any handrail thereon.

FIGS. 8A, 8B, and 8C illustrate respectively a side, front and rear view of another embodiment of a platform (105) in a deployed position. Here, the platform (105) is fixedly attached to the handcart (100) via a brace or bracket (125). The platform (105) is attached to the brace (125) by, but not limited to, a hinge member. Other means of attachment are also possible, as long as the platform (105) does not detach from the bracket (125).

FIG. 9 shows a front view the platform (105) of FIGS. 8A-8C, in a stored position. The bracket retracts back towards the frame of the handcart (100), and the platform (105) rests folded thereon. Here, the platform stored position is at the front of the handcart (100).

Movement of the platform (105) between deployed and stored positions may also be accomplished manually, or, through automated means.

In the embodiments described herein, the packaged items may comprise beverage bottles, or any good and/or raw material for sale and/or use in manufacturing. In addition, the packaged merchandise may comprise a tray within the packaging, or may be trayless.

### CONCLUSION

While specific embodiments have been described in detail in the foregoing detailed description and illustrated in the accompanying drawings, those with ordinary skill in the art will appreciate that various modifications and alternatives to those details may be developed in light of the overall teachings of the disclosure. Accordingly, the particular arrangements disclosed are meant to be illustrative only and not limiting as to the scope of the invention, which is to be given the full breadth of the appended claims and any and all equivalents thereof.

I/We claim:

1. A platform for the transfer of a plurality of items from a base level of a transportation device, to a second location, said platform comprising:
a) a frame;
b) a base for supporting said plurality of items, said base attached to said frame; and
c) one or more attachment members for engagement of said platform in both a deployed position and a stored position with said transportation device;
wherein said deployed position is at a higher level on said transportation device than said base level of said transportation device.

2. The platform of claim 1, further comprising a peripheral lip.

3. The platform of claim 2, wherein said peripheral lip is integral with said frame.

4. The platform of claim 1, wherein said platform is removably attached to said transportation device, such that one or more deployment attachment members are used to engage said platform in the deployed position, and one or more storage attachment members are used to engage said platform in said stored position.

5. The platform of claim 1, wherein said platform is fixedly attached to said transportation device.

6. The platform of claim 1, wherein said frame is made of lightweight material or steel, and said base is made of lightweight material.

7. The platform of claim 1, wherein said base is solid or has one or more perforations.

8. The platform of claim 1, wherein said plurality of items is packaged merchandise.

9. The platform of claim 8, wherein said packaged merchandise is trayless.

10. A platform for the transfer of a packaged items stored at a base level on a transportation device, to a second location, said platform removably attached to said transportation device, said platform comprising:
a) a frame;
b) a base for supporting said packaged items, said base attached to said frame;
c) one or more deployment attachment members for engaging said platform with said transportation device in a deployed position, and
d) one or more storage attachment members for engaging said platform in a stored position,
wherein said deployed position is at a level higher on said transportation device than said base level of said transportation device.

11. The platform of claim 10, wherein said base is solid or has one or more perforations.

12. The platform of claim 10 further comprising a peripheral lip.

13. The platform of claim 10, wherein said frame is made of the lightweight material or steel and said base is made of a lightweight material.

14. The platform of claim 10, wherein said packaged items are trayless.

15. A method of transferring and placing packaged items, comprising the steps of:
a) loading one or more units of said packaged items onto a base level of a transportation device, said transportation device having a platform in a stored position.removably attached thereto;
b) transporting the transportation device to a location where said packaged items are to be unloaded and placed;
c) removing said platform from said stored position;
d) attaching said platform in a deployed position onto said transportation device, said deployed position being at a level higher than said base level;
e) transferring one or more units of said packaged items from said base level onto said platform;
f) removing packaging from said packaged items;
g) placing said items removed from said packaging in step (f), onto a second location; and
h) repeating steps (e), (f) and (g) until most, or all, of said packaged items have been placed onto said second location;
wherein said platform comprises:
a frame;
a base for supporting said packaged items, said base attached to said frame;
one or more deployment attachment members for engaging said platform with said transportation device in said deployed position, and
one or more storage attachment members for engaging said platform in said stored position.

16. The method of any claim 15, wherein the platform further comprises a peripheral lip.

17. The method of claim 15, wherein the packaged items comprise beverage bottles.

18. A method of transferring and placing packaged items, comprising the steps of:
a) loading one or more units of said packaged items onto a base level of a transportation device, said transportation device having a platform in a stored position attached thereto;
b) transporting the transportation device to a location where said packaged items are to be unloaded and placed;
c) moving said platform from said stored position to a deployed position, said deployed position being at a level higher than said base level;
d) transferring one or more units of said packaged items from said base level onto said platform;
e) removing packaging from said packaged items;
f) placing said items removed from said packaging in step (e), onto a second location; and
g) repeating steps (d), (e) and (f) until most, or all, of said packaged items have been placed onto said second location;
wherein said platform comprises:
a frame;
a base for supporting said packaged items, said base attached to said frame; and
one or more attachment members for engagement of said platform in both said deployed position and said stored position with said transportation device.

19. The method of claim 18, wherein said platform is fixedly attached to said transportation device.

20. The method of claim 18, wherein said platform is removably attached to said transportation device, such that one or more deployment attachment members are used to engage said platform in said deployed position, and one or more storage attachment members are used to engage said platform in said stored position.
